(19) United States
(12) Patent Application Publication
(10) Pub. No.: US 2026/0322564 A1
(43) Pub. Date: Oct. 15, 2026

(54) CONFIGURATION INDICATION AND PROCESSING FOR DATA CHANNELS IN WIRELESS COMMUNICATIONS

(71) Applicant: ZTE CORPORATION, Shenzhen, Guangdong (CN)

(72) Inventors: Shuaihua KOU, Shenzhen (CN); Xianghui HAN, Shenzhen (CN); Wei GOU, Shenzhen (CN); Jing SHI, Shenzhen (CN)

(21) Appl. No.: 19/478,989

(22) PCT Filed: May 15, 2023
(86) PCT No.: PCT/CN2023/094295

§ 371 Date: Oct. 27, 2025

(51) Int. Cl. H04L 5/00; H04B 7/06

(52) U.S. Cl. CPC H04L 5/0092; H04B 7/0639

(57) ABSTRACT

A method for wireless communication is provided, and the method includes: configuring, by a network device, a first configuration for a data channel for a user device; indicating, by the network device, at least a subset of the first configuration to the user device; and communicating, by the network device between the user device, the data channel processed with the subset of the first configuration.

### CROSS-REFERENCE TO RELATED APPLICATION(S)

The present disclosure is a national phase entry under 35 USC 371 of International Patent Application No. PCT/CN2023/094295 filed on May 15, 2023, and the entire content of the International Patent Application is incorporated herein by reference.

### TECHNICAL FIELD

This document is directed generally to configurations for processing data channels in wireless communications.

### BACKGROUND

In wireless communication, the user equipment (UE) may have higher transmission requirements than what it can support. In this case, another UE can help this UE for data transmission if the two UEs can perform transmission between each other. This can improve the data transmission rate and reliability via data split and duplication. Ways to improve the transmission performance in such situations may be desirable.

### SUMMARY

This document relates to methods, systems, apparatuses and devices for wireless communication. In some implementations, a method for wireless communication includes: configuring, by a network device, a first configuration for a data channel for a user device; indicating, by the network device, at least a subset of the first configuration to the user device; and communicating, by the network device between the user device, the data channel processed with the subset of the first configuration.

In some other implementations, a method for wireless communication includes: receiving, by a user device from a network device, at least a subset of a first configuration for a data channel; and communicating, by the user device between the network device, the data channel processed with the subset of the first configuration.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a flow chart of a method for wireless communication.

FIG. 3 shows a flow chart of a method for wireless communication.

FIG. 4 shows a diagram of a downlink control information (DCI) and a physical uplink shared channel (PUSCH) for a determination of a subset of an antenna port configuration and/or a subset of a set of layers based on a subset of a precoding matrix.

### DETAILED DESCRIPTION

The present description describes various embodiments of systems, apparatuses, devices, and methods for wireless communications related to scheduling information determination for wireless communications.

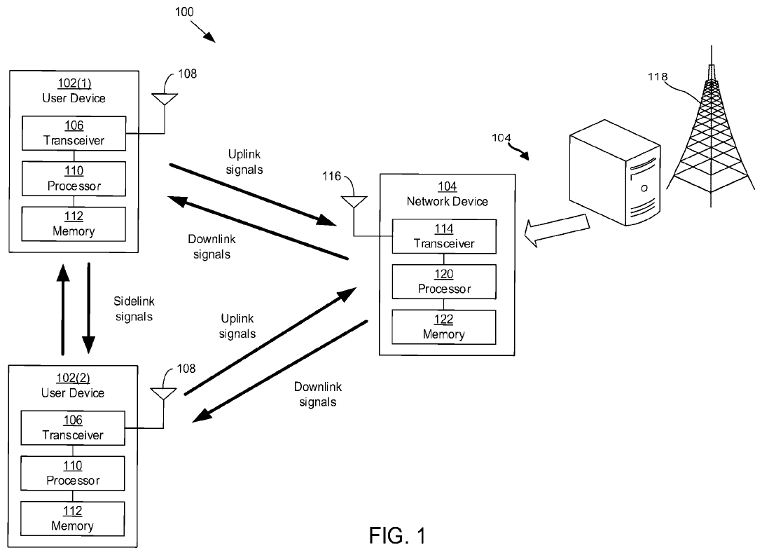

FIG. 1 shows a diagram of an example wireless communication system 100 (also referred to as a wireless system 100, or a system 100) including a plurality of communication nodes (or just nodes) that are configured to wirelessly communicate with each other. In general, the communication nodes include at least one user device 102 and at least one network device 104. The example wireless communication system 100 in FIG. 1 is shown as including two user devices 102, including a first user device 102(1) and a second user device 102(2), and one network device 104. However, various other examples of the wireless communication system 100 that include any of various combinations of one or more user devices 102 and/or one or more network devices 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples)) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 (also referred to as a transceiver 106) coupled to an antenna 108 to effect wireless communication with the network device 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a network device as described herein, such as the network device 104, may include a single electronic device or apparatus, or multiple (e.g., a network of) electronic devices or apparatuses, and may comprise one or more wireless access nodes, base stations, or other wireless network access points capable of communicating wirelessly over a network with one or more user devices and/or with one or more other network devices 104. For example, the network device 104 may comprise a 4G (Fourth Generation) LTE (Long Term Evolution) base station, a 5G (Fifth Generation) NR (New Radio) base station, a 5G central-unit base station, a 5G distributed-unit base station, a next generation Node B (gNB), an enhanced Node B (eNB), or other similar or next-generation (e.g., 6G) base stations, in various embodiments. A network device 104 may include transceiver circuitry 114 (also referred to as a transceiver 114) coupled to an antenna 116, which may include an antenna tower 118 in various approaches, to effect wireless communication with the user device 102 or another network device 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a network device 104, two user devices 102 without a network device 104, or two network devices 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a network device 104. A downlink signal is a signal transmitted from a network device 104 to a user device 102. A sidelink signal is a signal transmitted from a user device 102 to another user device 102, or a signal transmitted from one network device 104 to another network device 104. Also, for sidelink transmissions, a first/source user device 102 directly transmits a sidelink signal to a second/destination user device 102 without any forwarding of the sidelink signal to a network device 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a network device 104 to a user device 102. In other embodiments, the control information includes uplink control information (UCI) that is transmitted in the uplink direction from a user device 102 to a network device 104, or sidelink control information (SCI) that is transmitted in the sidelink direction from one user device 102(1) to another user device 102(2).

Additionally, in the wireless communication system, in some implementations, the second user device 102(2) may help the first user device 102(1) transmit data, including uplink (UL) data, downlink (DL) data, and/or sidelink (SL) data. The first user device 102(1) may be connected with the second user device 102(2) for the transmission between each other. In some implementations, the network device 104 may transmit the DL data of the first user device 102(1) to the second user device 102(2). In turn, the second user device 102(2) may forward the received DL data of the first user device 102(1) to the first user device 102(1). In addition or alternatively, for UL transmission, the first user device 102(1) may transmit its uplink data to the second user device 102(2). In turn, the second user device 102(2) may forward the received UL data of the first user device 102(1) to the network device 104. For sidelink transmission, the first user device 102(1) may transmit the data to the second user device 102(2). In turn, the second user device 102(2) may forward the received data to a third user device (not shown in FIG. 1). Alternatively, the third user device may transmit the data to the second user device 102(2). In turn, the second user device 102(2) may forward the received data to the first user device 102(1). In such situations, the first user device 102(1) may also be referred to as a remote user device (or UE) or an anchor user device (or UE). The second user device 102(1) may be referred to as an aggregated user device (or UE) or a relay user device (or UE). In some implementations, a remote user device may be connected with more than one relay user device. In some other implementations, a relay user device may be connected with more than one remote user device. The remote user device may also be connected with the network device 104 for uplink data and downlink data transmission or with the third user device for sidelink data transmission.

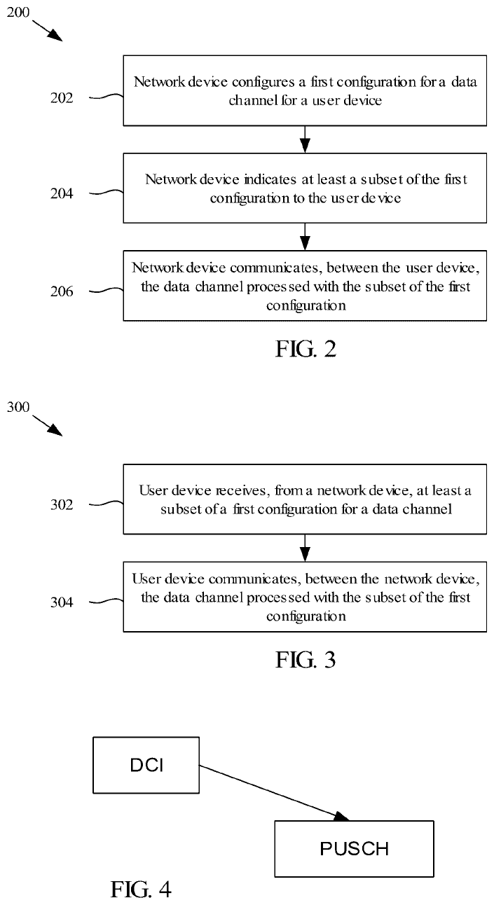

FIG. 2 shows a flow chart of an example method 200 for wireless communication involving configurations for data channels. At block 202, the network device 104 may configure a first configuration for a data channel for a user device 102. At block 204, the network device 104 may indicate at least a subset of the first configuration to the user device 102. At block 206, the network device 104 may communicate (including transmit and/or receive), between the user device, the data channel processed with the subset of the first configuration.

In some implementations of the method 200, the first configuration includes at least one of: a first antenna port configuration for the data channel, one or more layers of the data channel, or a precoding matrix for the data channel.

In some implementations of the method 200, the subset of the first configuration includes at least one of: a subset of a first antenna port configuration for the data channel, a subset of a total number of layers of the data channel, or a subset of a precoding matrix for the data channel.

In some implementations of the method 200, the network device 104 configures at least one of a coherent transmission or a first coherent group for the user device 102. For at least some of these implementations, the first coherent group corresponds to at least one of: a set of odd layers of the data channel, a set of odd antenna ports of the data channel, or a set of odd rows of a precoding matrix. In addition or alternatively, for at least some of these implementations, the network device 104 configures a second coherent group for a second user device 102(2). In some of these implementations involving a second coherent group, the second coherent group corresponds to at least one of: a set of even layers of the data channel, a set of even antenna ports of the data channel, or a set of even rows of a precoding matrix.

In some implementations of the method 200, the network device 104 indicates at least the subset of the first antenna port configuration for the data channel for the user device 102, where the user device 102 determines the subset of the total number of layers of the data channel or the subset of the precoding matrix for the data channel based on the subset of the first antenna port configuration.

In some implementations of the method 200, the network device 104 indicates at least the subset of the total number of layers for the data channel for the user device 102, wherein the user device 102 determines the subset of the first antenna port configuration for the data channel or the subset of the precoding matrix for the data channel based on the subset of a total number of layers.

In some implementations of the method 200, the network device 104 indicates at least the subset of the precoding matrix for the data channel for the user device 102, wherein the user device 102 determines the subset of the first antenna port configuration for the data channel or the subset of the total number of layers for the data channel based on the subset of the precoding matrix.

In some implementations of the method 200, a subset of a total number of layers of data is processed using a subset of a precoding matrix and transmitted using a subset of antenna ports.

FIG. 3 shows a flow chart of another example method 300 for wireless communication involving configurations for data channels. At block 302, a user device 102 receives, from a network device 104, at least a subset of a first configuration for a data channel. At block 304, the user device 102 communicates, between the network device 104, the data channel processed with the subset of the first configuration.

In some implementations of the method 300, the first configuration includes at least one of: a first antenna port configuration for the data channel, one or more layers of the data channel, or a precoding matrix for the data channel.

In some implementations of the method 300, the subset of the first configuration includes at least one of: a subset of a first antenna port configuration for the data channel, a subset of a total number of layers of the data channel, or a subset of a precoding matrix for the data channel.

In some implementations of the method 300, the subset of the first configuration includes a subset of a first antenna port configuration for the data channel, and the user device 102 determines a subset of a total number of layers of the data channel or a subset of a precoding matrix for the data channel based on the subset of the first antenna port configuration received from the network device 104.

In some implementations of the method 300, the subset of the first configuration includes a subset of a total number of layers for the data channel, and the user device 102 determines a subset of the first antenna port configuration for the data channel or a subset of a precoding matrix for the data channel based on the subset of the total number of layers received from the network device 104.

In some implementations of the method 300, the subset of the first configuration includes a subset of a precoding matrix for the data channel, and the user device 102 determines a subset of a first antenna port configuration for the data channel or a subset of a total number of layers for the data channel based on the subset of the precoding matrix received from the network device 104.

In some implementations of the method 300, the user device 102 receives at least one of a coherent transmission or a first coherent group configured by the network device 104, and the user device selects at least one of: a subset of a total number of layers for the data channel, a subset of a first antenna port configuration of the data channel, or a subset of a precoding matrix for the data channel according to the first coherent group. In some of these implementations, the first coherent group corresponds to at least one of: a set of odd layers of the data channel, a set of odd antenna ports of the data channel, or a set of odd rows of a precoding matrix. In some of these implementations, the user device 102 processes at least one of: only the set of odd layers of the data channel or only the set of odd rows of the precoding matrix when the user device 102 is configured with the first coherent group.

In some implementations of the method 300, the user device 102 receives at least one of a coherent transmission or a second coherent group configured by the network device 104, and the user device 102 selects at least one of: a subset of a total number of layers for the data channel, a subset of a first antenna port configuration of the data channel, or a subset of a precoding matrix for the data channel according to the second coherent group. In some of these implementations, the second coherent group corresponds to at least one of: a set of even layers of the data channel, a set of even antenna ports of the data channel, or a set of even rows of a precoding matrix.

In some implementations of the method 300, the user device 102 processes at least one of: only the set of even layers of the data channel or only the set of even rows of the precoding matrix when the user device is configured with the second coherent group.

In some implementations of the method 300, a subset of a total number of layers of data is processed using a subset of a precoding matrix and transmitted using a subset of antenna ports.

In some implementations, the network device 104 may configure (or indicate) a first configuration for a data channel for a user device 102 (e.g., the first user device 102(1) or the second user device 102(2)). In turn, or in response, the user device 102 may use the first configuration for data channel processing, such as communicating (receiving or transmitting) the data channel. In some other implementations, the user device 102 may select a subset of the first configuration. In turn, or in response, the user device 102 may use the subset of the first configuration for the data channel processing.

In one implementation, the user device 102 may use the subset of the first configuration for processing all data channels. In another implementation, a first data channel may be scheduled by a first control information (e.g., a first DCI), or may be configured by the network device 104, such as via radio resource control (RRC) signaling and/or via the first control information (e.g., a first DCI). In addition or alternatively, a second data channel may be scheduled by a second control information (e.g., a second DCI), or may be configured by the network device 104, such as via RRC signaling and/or via the second control information (e.g., the second DCI).

The user device 102 may use the first configuration to process the first data channel. In addition or alternatively, the user device 102 may use the subset of the first configuration for processing the second data channel. In some implementations, the first DCI may be scrambled by a first radio network temporary identifier (RNTI), or transmitted in a first control resource set or on the PDCCH monitoring occasion of a first search space configuration. In addition or alternatively, the second DCI may be scrambled by a second RNTI, or transmitted in a second control resource set or on the PDCCH monitoring occasion of the second search space configuration. In addition or alternatively, in some implementations, the DCI may include a field that has a first value or a second value. The first value of the field may indicate that the DCI is the first DCI. The second value of the field may indicate that the DCI is the second DCI. Also, in any of various implementations, the data channel may be or include a PDSCH, a PUSCH, or a PSSCH.

Additionally, in some implementations, the network device 104 may configure a first configuration that may be larger than the user device 102 capability. The network device 104 may configure the subset of the first configuration that may not be larger than the user device 102 capability.

In addition or alternatively, in some implementations, the first configuration may include and/or indicate at least an antenna port. For example, the network device 104 may configure (or indicate) a first antenna port configuration for the user device 102. The first antenna port configuration may include at least one of: a number of antenna ports or a port number. In addition or alternatively, the network device 104 may configure a subset of the first antenna port configuration for the user device 102. In particular of these implementations, the network device 104 may configure the first antenna port configuration to include N antenna ports, where N is an integer greater than or equal to 1. The network device 104 configuring the first antenna port configuration in this way may, in turn, cause the user device 102 to select at least one of the N antenna ports for the data channel processing. The antenna port may be for a demodulation reference signal (DMRS) of the data channel. The first configuration including or indicating an antenna port may imply or indicate that the user device 102 may communicate (transmit or receive) the DMRS of the data channel by using the configured antenna port configuration or the subset of the configured antenna port configuration (e.g., by using at least one antenna port included in the first antenna port configuration). The network device 104 may configure a first antenna port configuration that may be larger than the user device 102 capability. The network device 104 may configure the subset of the first antenna port configuration that may not be larger than the user device 102 capability. For example, the user device 102 may be able to support at most N1 antenna ports. The network device 104 may configure a first antenna port configuration that may include N antenna ports, and N may be greater than N1. The network device 104 may configure a subset of the antenna ports that may include N2 antenna ports of the N antenna ports, and N2 may not be greater than N1.

In addition or alternatively, in some implementations, the first configuration may include at least a precoding matrix. For example, the network device 104 may configure (or indicate) a precoding matrix for a data channel for the user device 102. In turn, or in response, the user device 102 may use the configured precoding matrix for processing the data channel. In addition or alternatively, in some implementations, the user device 102 may select a subset of the configured precoding matrix for processing the data channel. In particular of these implementations, the configured precoding matrix may include X rows and Y columns. The user device 102 may select at least one of (and in some cases fewer than) the X rows and/or at least one of (and in some cases fewer than) the Y columns of the precoding matrix for processing the data channel. The network device 104 may configure a precoding matrix that may be larger than the user device 102 capability. The network device 104 may configure the subset of the precoding matrix that may not be larger than the user device 102 capability. For example, the user device 102 may be able to support at most X1 rows and Y1 columns for the precoding matrix. The network device 104 may configure the precoding matrix that may include X rows and Y columns, and X may be greater than X1, and Y may be greater than Y1. The network device may configure a subset of the precoding matrix that may include X2 rows and Y2 columns, and X2 may not be greater than X1, and Y2 may not be greater than Y1.

In addition or alternatively, in some implementations, the first configuration may include at least one layer (also referred to as a data layer) of the data channel. The network device 104 may configure (or indicate) a number (e.g., a total number) of layers for a data channel for the user device 102. In turn, or in response, the user device 102 may use the configured number of layers for processing the data channel. In addition or alternatively, the user device 102 may select a subset of the configured layers (or a subset of a total number of the configured layers) for processing the data channel. For example, the network device 104 may configure (or indicate) Z layers (where Z is an integer greater than or equal to 1) for the data channel. The user device 102 may select at least one of (and in some cases less than) the Z layers for the data channel processing. Configuration of the Z layers may imply or indicate that the network device 104 may configure the data channel to include Z-layer data. In turn, or in response, the user device 102 may process only some of the Z-layer data. The network device 104 may configure a number of layers that may be larger than the user device 102 capability. The network device 104 may configure the subset of the number of layers that may not be larger than the user device 102 capability. For example, the user device 102 may be able to support at most Z1 layers. The network device 104 may configure a number of layers that may include Z layers and Z may be greater than Z1. The network device may configure a subset of the number of layers that may include Z2 layers, and Z2 may not be greater than Z1.

Additionally, in some implementations, for scheduling a data channel for a user device 102, the network device 104 may indicate the first configuration via DCI or RRC signaling. For example, for a data channel, the network device 104 may indicate the precoding matrix that includes X rows and Y columns, and/or N antenna ports, and/or Z layers. The network device 104 may indicate the antenna port number for the data channel based on the N antenna ports. The network device 104 may indicate which precoding matrix is used for the data channel from the precoding matrices with X rows and Y columns. The user device 102 may use the subset of the first configuration for processing the data channel.

In addition or alternatively, in some embodiments, the network device 104 may indicate the subset of the first configuration for scheduling a data channel for a user device 102 via DCI or RRC signaling. For example, for a data channel, the network device 104 may indicate Z2 layers. It means that the data channel has Z2 layers. The Z2 layers may be the subset of the Z layers in accordance with the embodiments. The user device 102 may process the data by using Z layers before the precoding. The user device 102 may process the data by using Z2 layers after the precoding. Additionally, the user device 102 may determine a transport block size by using Z layers. After layer mapping, the user device 102 may determine that the data has Z layers. The user device 102 may select the Z2 layers data from the Z layers. The user device 102 may further process the Z2 layers data and transmit the Z2 layers data.

To illustrate, the network device 104 may indicate two layers for a data channel to the user device 102. The network device 104 may indicate the precoding matrix that may correspond to the two layers. The network device 104 may configure that the two layers are the odd layers of the data with four layers (e.g., the first layer and the third layer). The user device 102 may use the four layers to determine the transport block size for the data channel. After layer mapping, the output may be

$$[ \begin{matrix}{x}^{( 0 )} \\ {x}^{( 1 )} \\ {x}^{( 2 )} \\ {x}^{( 3 )}\end{matrix} ] .$$

Then the user device 102 may select the first layer data and the third layer data, i.e.,

$$[ \begin{matrix}{x}^{( 0 )} \\ {x}^{( 2 )}\end{matrix} ] ,$$

for further processing. In addition or alternatively, the network device 104 may configure that the two layers are the even layers of the data with four layers (e.g., the second layer and the fourth layer). Then the user device 102 may select the second layer data and the fourth layer data, i.e.,

$$[ \begin{matrix}{x}^{( 1 )} \\ {x}^{( 3 )}\end{matrix} ] ,$$

for further processing.

In addition or alternatively, the first user device 102(1) may report the total capability of the first user device 102(1) and the second user device 102(2) to the network device 104. The network device 104 may configure the configuration for a data channel for the first user device 102(1) based on the total capability reported by the first user device 102(1). The first user device 102(1) may send the configuration to the second user device 102(2). The first user device 102(1) or the second user device 102(2) may select the subset of the configuration for the data channel processing. The subset of the configuration may be determined by the first user device 102(1) or the second user device 102(2).

In some implementations, the first user device 102(1) may support at most N₁ antenna ports. The second user device 102(2) may support at most N₂ antenna ports. The first user device 102(1) may report to the network device 104 that at most N₁+N₂ antenna ports can be supported. The network device 104 may configure a configuration of N₁+N₂ (or a value less than N₁+N₂) antenna ports for a data channel. Then the first user device 102(1) may send the configuration of N₁+N₂ (or a value less than N₁+N₂) antenna ports for the data channel to the second user device 102(2). The first user device 102(1) may use the subset of the configuration of N₁+N₂ (or a value less than N₁+N₂) antenna ports for processing the data channel. The second user device 102(2) may use the subset of the configuration of N₁+N₂ (or a value less than N₁+N₂) antenna ports for processing the data channel.

In some implementations, the first user device 102(1) may support at most Z₁ layers for the data channel. The second user device 102(2) may support at most Z₂ layers for the data channel. The first user device 102(1) may report to the network device 104 that at most Z₁+Z₂ layers can be supported. The network device 104 may configure a configuration of Z₁+Z₂ (or a value less than Z₁+Z₂) layers for a data channel. Then the first user device 102(1) may send the configuration of Z₁+Z₂ (or a value less than Z₁+Z₂) layers for the data channel to the second user device 102(2). The first user device 102(1) may use the subset of the configuration of Z₁+Z₂ (or a value less than Z₁+Z₂) layers for processing the data channel. The second user device 102(2) may use the subset of the configuration of Z₁+Z₂ (or a value less than Z₁+Z₂) layers for processing the data channel.

In some implementations, the first user device 102(1) may support the precoding matrix with at most X₁ rows and/or Y₁ columns for the data channel. The second user device 102(2) may support the precoding matrix with at most X₂ rows and/or Y₂ columns for the data channel. The first user device 102(1) may report to the network device 104 that a precoding matrix with at most X₁+X₂ rows and/or Y₁+Y₂ columns can be supported. The network device 104 may configure a configuration of the precoding matrix with X₁+X₂ rows and/or Y₁+Y₂ columns (or the precoding matrix with the number of rows less than X₁+X₂ and/or the number of columns less than Y₁+Y₂) for a data channel. Then the first user device 102(1) may send the configuration of the precoding matrix with X₁+X₂ rows and/or Y₁+Y₂ columns (or the precoding matrix with the number of rows less than X₁+X₂ and/or the number of columns less than Y₁+Y₂) for the data channel to the second user device 102(2). The first user device 102(1) may use the subset of the configuration of the precoding matrix with X₁+X₂ rows and/or Y₁+Y₂ columns (or the precoding matrix with the number of rows less than X₁+X₂ and/or the number of columns less than Y₁+Y₂) for processing the data channel. The second user device 102(2) may use the subset of the configuration of the precoding matrix with X₁+X₂ rows and/or Y₁+Y₂ columns (or the precoding matrix with the number of rows less than X₁+X₂ and/or the number of columns less than Y₁+Y₂) for processing the data channel.

In addition or alternatively, in some embodiments, the network device 104 may configure how the user device 102 is to select a subset of the first antenna port configuration. In some implementations, the network device 104 may configure the subset of the first antenna port configuration for the user device 102. For example, the network device 104 may configure the subset of the first antenna port configuration to include a first (or initial) one or more antenna ports of the N antenna ports, a last one or more antenna ports of the N antenna ports, the odd antenna ports (e.g., the first antenna port, the third antenna port, the fifth antenna port, and so on) of the N antenna ports, or the even antenna ports (e.g., the second, the fourth, the sixth antenna port, and so on) of the N antenna ports.

In addition or alternatively, in some embodiments, the network device 104 may configure how the user device 102 is to select a subset of the precoding matrix. The network device 104 may configure the subset of the precoding matrix for the user device 102. For example, the network device 104 may configure the subset of the precoding matrix to be at least one of, or a combination of, the first one or more rows, the last one or more rows, the odd rows (e.g., the first row, the third row, the fifth row, and so on), the even rows (e.g., the second row, the fourth row, the sixth row, and so on) of the X rows, and/or the first one or more columns, the last one or more columns, the odd columns (e.g., the first column, the third column, the fifth column, and so on), or the even columns (e.g., the second column, the fourth column, the sixth column, and so on) of the Y columns. In some implementations, if one column of the subset of the precoding matrix includes all ‘zeros’ (e.g., all the elements of the column of the subset of the precoding matrix are zero), then this column may be removed from the subset of the precoding matrix.

In addition or alternatively, in some implementations, the network device 104 may configure how the user device 102 is to select a subset of the layers. The network device 104 may configure the subset of the layers for the user device 102. For example, the network device 104 may configure the subset of the layers to be the first one or more layers, the last one or more layers, the odd layers (e.g., the first layer, the third layer, the fifth layer, and so on), or the even layers (e.g., the second layer, the fourth layer, the sixth layer, and so on) of the Z layers.

In addition or alternatively, in some embodiments, the network device 104 may configure only one of: the subset of the precoding matrix configuration, the subset of the antenna port configuration, or the subset of the layer configuration. In turn, or in response, the user device 102 may determine or derive one or more of the other subset configuration based on the subset configuration configured by the network device 104.

In addition or alternatively, in some implementations, the network may only configure the subset of the precoding matrices for the UE. The UE may determine the subset of the antenna port from the first antenna port configuration according to the configuration of the subset of the precoding matrix. The UE may determine the subset of the layers from the configured layers according to the configuration of the subset of the precoding matrix.

In some of these implementations, the network device 104 may configure the subset of the precoding matrix for the user device 102 to include the odd rows (or only the odd rows) of the precoding matrix. In turn, or in response, the user device 102 may determine that the subset of the antenna port includes (or only includes) the odd antenna ports of the first antenna port configuration. In a first case, in event that the subset of the precoding matrix includes a column comprising all ‘zeros’, then the user device 102 may determine that the subset of the layers may include all of the configured layers. In event that the column comprising all ‘zeros’ is removed from the subset of the precoding matrix, the user device 102 may determine that the subset of the layers may include (or only include) the odd layers of the configured layers. In a second case, in event that a coherent transmission is configured (or indicated) for the user device 102, the user device 102 may determine that the subset of the layers includes all of the configured layers. In event that a non-coherent transmission or partial coherent transmission is configured (or indicated) for the user device 102, the user device 102 may determine that the subset of the layers includes the odd layers (or only the odd layers) of the configured layers. In event that the non-coherent transmission or partial coherent transmission is configured (or indicated) for the user device 102, the user device 102 may remove the column that includes all ‘zeros’ from the subset of the precoding matrix.

In other of these implementations, the network device 104 may configure the subset of the precoding matrix for the user device 102 to include (or only include) the even rows of the precoding matrix. In turn, or in response, the user device 102 may determine that the subset of the antenna port includes (or only includes) the even antenna ports of the first antenna port configuration. In a first case, in event that the subset of the precoding matrix includes a column comprising all ‘zeros’, then the user device 102 may determine that the subset of the layers includes all of the configured layers. In event that the column comprising all ‘zeros’ is removed from the subset of the precoding matrix, the user device 102 may determine that the subset of the layers may include (or only include) the even layers of the configured layers. In another case, in event that the coherent transmission is configured (or indicated) for the user device 102, the user device 102 may determine that the subset of the layers may include all the configured layers. In event that a non-coherent transmission or partial coherent transmission is configured (or indicated) for the user device 102, the user device 102 may determine that the subset of the layers includes (or only includes) the even layers of the configured layers. In event that the non-coherent transmission or partial coherent transmission is configured (or indicated) for the user device 102, the user device 102 may remove the column that includes all ‘zeros’ from the subset of the precoding matrix.

Additionally, in any of various implementations, a transmission mode may be a coherent transmission, a non-coherent transmission, or a partial coherent transmission. The network device 104 may configure a transmission mode for a user device 102, such as via RRC signaling and/or via a precoding matrix. Using a precoding matrix may be a way for the network device 104 to implicitly or implicitly configure a transmission mode for the user device 102. That is to say, the network device 104 may directly configure a coherent transmission, a non-coherent transmission, or a partial coherent transmission via RRC signaling. In addition or alternatively, the network device 104 may indirectly, implicitly, and/or implicitly configure (or indicate) a non-coherent transmission for the data channel for the user device 102 via a precoding matrix. Table 1 below includes a set of precoding matrices with non-coherent transmission. The network device 104 configuring (or indicating) any one of the precoding matrices in Table 1 for a data channel means that non-coherent transmission is configured (or indicated) for the data channel for the user device 102.

TABLE 1
Precoding matrix with non-coherent transmission

| | | | | |
|---|---|---|---|---|
| Precoding matrix for single-layer transmission using two antenna ports | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | | |
| Precoding matrix for single-layer transmission using four antenna ports with transform precoding enabled | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ |
| Precoding matrix for single-layer transmission using four antenna ports with transform precoding disabled | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ |
| Precoding matrix for two- layer transmission using two antenna ports with | $\frac{1}{\sqrt{2}} [ \begin{matrix}1 & 0 \\ 0 & 1\end{matrix} ]$ | | | |
| transform precoding | | | | |
| disabled | | | | |
| Precoding matrix for two- layer transmission using four antenna ports with transform precoding disabled | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | | |
| Precoding matrix for three-layer transmission using four antenna ports with transform precoding disabled | $\frac{1}{2} [ \begin{matrix}1 & 0 & 0 \\ 0 & 1 & 0 \\ 0 & 0 & 1 \\ 0 & 0 & 0\end{matrix} ]$ | | | |
| Precoding matrix for four- layer transmission using four antenna ports with transform precoding disabled. | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | | | |

In addition or alternatively, the network device 104 may configure (or indicate) partial coherent transmission for the data channel for the user device 102 via a precoding matrix. Table 2 below includes precoding matrices with partial coherent transmission. The network device 104 configuring (or indicating) any one of the precoding matrices in Table 2 for a data channel may mean that partial coherent transmission is configured (or indicated) for the data channel for the user device 102.

TABLE 2
Precoding matrix with partial coherent transmission

| | | | | |
|---|---|---|---|---|
| Precoding matrix for single-layer transmission using four antenna ports with transform precoding | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| enabled | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ |
| Precoding matrix for single-layer transmission using four antenna ports with transform precoding | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| disabled | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ |
| Precoding matrix for two-layer transmission using four antenna ports with transform precoding disabled | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ |
| | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ |
| Precoding matrix for three-layer transmission using four antenna ports with transform precoding | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | | |
| disabled | | | | |

| | | |
|---|---|---|
| Precoding matrix for four-layer transmission using four antenna ports with transform precoding disabled. | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ |

In addition or alternatively, the network device 104 may configure (or indicate) coherent transmission for the data channel for the user device 102 via the precoding matrix. Table 3 below includes precoding matrices with coherent transmission. The network device 104 configuring (or indicating) any one of the precoding matrices in Table 3 for a data channel may mean that coherent transmission is configured (or indicated) for the data channel for the user device 102.

TABLE 3
Precoding matrix with coherent transmission

| | | | | |
|---|---|---|---|---|
| Precoding matrix for one layer | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ |
| transmission | | | | |
| using two | | | | |
| antenna ports | | | | |
| Precoding matrix for single-layer transmission using four | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| antenna ports with transform precoding enabled | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ |
| | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ |
| Precoding matrix for single-layer transmission using four | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| antenna ports with transform precoding disabled | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ |
| | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ |
| Precoding matrix for two-layer | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ | | |
| transmission | | | | |
| using two | | | | |
| antenna ports | | | | |
| with transform | | | | |
| precoding | | | | |
| disabled | | | | |
| Precoding matrix for two-layer transmission using four | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ |
| antenna ports with transform precoding disabled | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ |
| Precoding matrix for three-layer transmission using four | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ |
| antenna ports | | | | |
| with transform | | | | |
| precoding | | | | |
| disabled | | | | |
| Precoding matrix for four-layer transmission using four | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | | |
| antenna ports | | | | |
| with transform | | | | |
| precoding | | | | |
| disabled. | | | | |

FIG. 4 illustrates an example of a determination of a subset of an antenna port configuration and/or a subset of a set of layers based on a subset of a precoding matrix. A DCI may schedule a PUSCH for the first user device 102(1) or the second user device 102(2). The network device 104 may configure, for example, the first row and the third row of the precoding matrix for the first user device 102(1). In addition, the network device 104 may configure, for example, the second row and the fourth row of the precoding matrix for the second user device 102(2).

Further in the example, suppose that the DCI indicates the following precoding matrix

$$\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$$

for a PUSCH, and the DCI indicates antenna port 0, antenna port 1, antenna port 2, and antenna port 3 for the PUSCH. The first user device 102(1) or the second user device 102(2) may process the data for the PUSCH. After processing (e.g., layer mapping), the data layers are

$$[ \begin{matrix}{x}^{( 1 )} \\ {x}^{( 2 )} \\ {x}^{( 3 )} \\ {x}^{( 4 )}\end{matrix} ] ,$$

where x⁽¹⁾ is the data of the first layer, x⁽²⁾ is the data of the second layer, x⁽³⁾ is the data of the third layer, and x⁽⁴⁾ is the data of the fourth layer. As used herein, the term x^{( . . . )} may represent an information bit sequence or a modulated symbol sequence.

Based on the precoding matrix subset configuration, the first user device 102(1) may determine that the antenna port subset includes antenna port 0 and antenna port 2. The first user device 102(1) may transmit the PUSCH DMRS by using antenna port 0 and antenna port 2. The second user device 102(2) may determine that the antenna port subset includes antenna port 1 and antenna port 3. The second user device 102(2) may transmit the PUSCH DMRS by using antenna port 1 and antenna port 3.

In a first example, the first user device 102(1) may select a precoding matrix subset:

$$\frac{1}{2} [ \begin{matrix}1 & 0 & 0 & 0 \\ 0 & 0 & 1 & 0\end{matrix} ] .$$

In this example, since the second column and the fourth column each include all ‘zeros’, the two columns may be removed. The first user device 102(1) may determine the precoding matrix subset to be

$$\frac{1}{2} [ \begin{matrix}1 & 0 \\ 0 & 1\end{matrix} ] .$$

Based on this the first user device 102(1) may select the first layer (i.e., x⁽¹⁾ and the third layer (i.e., x⁽³⁾) of the data for processing. The output after precoding is

$$\frac{1}{2} [ \begin{matrix}{x}^{( 1 )} \\ {x}^{( 3 )}\end{matrix} ] ,$$

which is obtained by

$$\frac{1}{2} [ \begin{matrix}1 & 0 \\ 0 & 1\end{matrix} ] ⋆ [ \begin{matrix}{x}^{( 1 )} \\ {x}^{( 3 )}\end{matrix} ] .$$

The first user device 102(1) may transmit the output data

$$\frac{1}{2} [ \begin{matrix}{x}^{( 1 )} \\ {x}^{( 3 )}\end{matrix} ] .$$

Additionally, the second user device 102(2) may select the second row and the fourth row of the precoding matrix for processing PUSCH, i.e., the precoding matrix subset

$$\frac{1}{2} [ \begin{matrix}0 & 1 & 0 & 0 \\ 0 & 0 & 0 & 1\end{matrix} ] .$$

Since the first column and the third column each include all ‘zeros’, the two columns may be removed. The second user device 102(2) may determine the precoding matrix subset to be

$$\frac{1}{2} [ \begin{matrix}1 & 0 \\ 0 & 1\end{matrix} ] .$$

Based on this, the second user device 102(2) may select the second layer (i.e., x⁽²⁾) and the third layer (i.e., x⁽³⁾) of the data for processing. The output after precoding is

$$\frac{1}{2} [ \begin{matrix}{x}^{( 2 )} \\ {x}^{( 4 )}\end{matrix} ] ,$$

which is obtained by

$$\frac{1}{2} [ \begin{matrix}1 & 0 \\ 0 & 1\end{matrix} ] ⋆ [ \begin{matrix}{x}^{( 2 )} \\ {x}^{( 4 )}\end{matrix} ] .$$

The second user device 102(2) may transmit the output data

$$\frac{1}{2} [ \begin{matrix}{x}^{( 2 )} \\ {x}^{( 4 )}\end{matrix} ] .$$

In a second example, the first user device 102(1) may select a precoding matrix subset:

$$\frac{1}{2} [ \begin{matrix}1 & 0 & 0 & 0 \\ 0 & 0 & 1 & 0\end{matrix} ] .$$

In turn, the first user device 102(1) may select all of the layers of the data, i.e., x⁽¹⁾, x⁽²⁾, x⁽³⁾, and x⁽⁴⁾. After precoding, the output is

$$\frac{1}{2} [ \begin{matrix}{x}^{( 1 )} \\ 0 \\ {x}^{( 3 )} \\ 0\end{matrix} ] ,$$

which is obtained by

$$\frac{1}{2} [ \begin{matrix}1 & 0 & 0 & 0 \\ 0 & 0 & 1 & 0\end{matrix} ] ⋆ [ \begin{matrix}{x}^{( 1 )} \\ {x}^{( 2 )} \\ {x}^{( 3 )} \\ {x}^{( 4 )}\end{matrix} ] .$$

The first user device 102(1) may transmit output

$$\frac{1}{2} [ \begin{matrix}{x}^{( 1 )} \\ 0 \\ {x}^{( 3 )} \\ 0\end{matrix} ] .$$

It means that the second user device 102(2) may only transmit the data of a

$$\frac{1}{2} [ \begin{matrix}{x}^{( 1 )} \\ {x}^{( 3 )}\end{matrix} ] .$$

The second user device 102(2) may select the precoding subset

$$\frac{1}{2} [ \begin{matrix}0 & 1 & 0 & 0 \\ 0 & 0 & 0 & 1\end{matrix} ] .$$

In turn, the second user device 102(2) may select all of the layers of the data, i.e., x⁽¹⁾, x⁽²⁾, x⁽³⁾, and x⁽⁴⁾. After precoding, the output is

$$\frac{1}{2} [ \begin{matrix}{x}^{( 2 )} \\ 0 \\ {x}^{( 4 )} \\ 0\end{matrix} ] ,$$

which is obtained by

$$\frac{1}{2} [ \begin{matrix}0 & 1 & 0 & 0 \\ 0 & 0 & 0 & 1\end{matrix} ] ⋆ [ \begin{matrix}{x}^{( 1 )} \\ {x}^{( 2 )} \\ {x}^{( 3 )} \\ {x}^{( 4 )}\end{matrix} ] .$$

The second user device 102(2) may transmit the output

$$[ \begin{matrix}{x}^{( 2 )} \\ 0 \\ {x}^{( 4 )} \\ 0\end{matrix} ] .$$

It means that the second user device 102(2) may only transmit the data of

$$\frac{1}{2} [ \begin{matrix}{x}^{( 2 )} \\ {x}^{( 4 )}\end{matrix} ] .$$

In addition or alternatively, in an example of determining a subset of an antenna port configuration and/or a subset of a layer configuration based on a subset of a precoding matrix, suppose that a DCI indicates a precoding matrix

$$\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$$

for a PUSCH. Additionally, suppose that the DCI indicates antenna port 0, antenna port 1, antenna port 6, and antenna port 7 for the PUSCH. The first user device 102(1) or the second user device 102(2) may process the data for the PUSCH.

In this example, based on the precoding matrix subset configuration, the first user device 102(1) may determine that the antenna port subset includes antenna port 0 and antenna port 6. The first user device 102(1) may transmit the PUSCH DMRS by using antenna port 0 and antenna port 6. Additionally, the second user device 102(2) may determine that the antenna port subset includes antenna port 1 and antenna port 7. The second user device 102(2) may transmit the PUSCH DMRS by using antenna port 1 and antenna port 7.

Additionally, in this example, the precoding matrix may indicate the partial coherent transmission for PUSCH for the first user device 102(1) or the second user device 102(2). The first user device 102(1) may determine that the subset of the data layers includes the first layer (i.e., x⁽¹⁾) and the third layer (i.e., x⁽³⁾). The first row and the third row of the precoding matrix are

$$\frac{1}{2 \sqrt{2}} [ \begin{matrix}1 & 1 & 0 & 0 \\ 1 & - 1 & 0 & 0\end{matrix} ] .$$

The first user device 102(1) may determine that the subset of the precoding matrix is

$$\frac{1}{2 \sqrt{2}} [ \begin{matrix}1 & 1 \\ 1 & - 1\end{matrix} ]$$

by removing the third column and the fourth column that include all ‘zeros’. After precoding, the output is

$$\frac{1}{2 \sqrt{2}} [ \begin{matrix}{x}^{( 1 )} & + & {x}^{( 3 )} \\ {x}^{( 1 )} & - & {x}^{( 3 )}\end{matrix} ] ,$$

which is obtained by

$$\frac{1}{2 \sqrt{2}} [ \begin{matrix}1 & 1 \\ 1 & - 1\end{matrix} ] ⋆ [ \begin{matrix}{x}^{( 1 )} \\ {x}^{( 3 )}\end{matrix} ] .$$

The first user device 102(1) may transmit the output

$$\frac{1}{2 \sqrt{2}} [ \begin{matrix}{x}^{( 1 )} & + & {x}^{( 3 )} \\ {x}^{( 1 )} & - & {x}^{( 3 )}\end{matrix} ] .$$

Additionally, in this example, the second user device 102(2) may determine that the subset of the data layers includes the second layer (i.e., x⁽²⁾) and the fourth layer (i.e., x⁽⁴⁾). The second row and the fourth row of the precoding matrix are

$$\frac{1}{2 \sqrt{2}} [ \begin{matrix}0 & 0 & 1 & 1 \\ 0 & 0 & 1 & - 1\end{matrix} ] .$$

The second user device 102(2) may determine that the subset of the precoding matrix is

$$\frac{1}{2 \sqrt{2}} [ \begin{matrix}1 & 1 \\ 1 & - 1\end{matrix} ]$$

by removing the first column and the second column that include all ‘zeros’. After precoding, the output is

$$\frac{1}{2 \sqrt{2}} [ \begin{matrix}{x}^{( 2 )} & + & {x}^{( 4 )} \\ {x}^{( 2 )} & - & {x}^{( 4 )}\end{matrix} ] ,$$

which is obtained by

$$\frac{1}{2 \sqrt{2}} [ \begin{matrix}1 & 1 \\ 1 & - 1\end{matrix} ] ⋆ [ \begin{matrix}{x}^{( 2 )} \\ {x}^{( 4 )}\end{matrix} ] .$$

The second user device 102(2) may transmit the output

$$\frac{1}{2 \sqrt{2}} [ \begin{matrix}{x}^{( 2 )} & + & {x}^{( 4 )} \\ {x}^{( 2 )} & - & {x}^{( 4 )}\end{matrix} ] .$$

Additionally, in another example of determining a subset of antenna ports and/or a subset of layers based on a subset of a precoding matrix, suppose that a DCI indicates the following precoding matrix:

$$\frac{1}{4} [ \begin{matrix}1 & 1 & 1 & 1 \\ 1 & - 1 & 1 & - 1 \\ j & j & - j & - j \\ j & - j & - j & j\end{matrix} ]$$

for a PUSCH. Additionally, suppose that the DCI indicates antenna port 4, antenna port 5, antenna port 10, and antenna port 11 for the PUSCH. This precoding matrix may indicate the coherent transmission for PUSCH for the first user device 102(1) or the second user device 102(2).

In this example, the first user device 102(1) may select the precoding matrix subset

$$\frac{1}{4} [ \begin{matrix}1 & 1 & 1 & 1 \\ j & j & - j & - j\end{matrix} ] .$$

Since the coherent transmission is indicated for the PUSCH, the first user device 102(1) may select all of the layers of the data, i.e., x⁽¹⁾, x⁽²⁾, x⁽³⁾, and x⁽⁴⁾. Also, the first user device 102(1) may select antenna port 4 and antenna port 10 for the PUSCH transmission. After precoding, the output is

$$\frac{1}{4} [ \begin{matrix}{x}^{( 1 )} + {x}^{( 2 )} + {x}^{( 3 )} + {x}^{( 4 )} \\ j * {x}^{( 1 )} + j * {x}^{( 2 )} - j * {x}^{( 3 )} - j * {x}^{( 4 )}\end{matrix} ] ,$$

which is transmitted by the first user device 102(1).

Additionally, in this example, the second user device 102(2) may select the precoding matrix subset

$$\frac{1}{4} [ \begin{matrix}1 & - 1 & 1 & - 1 \\ j & - j & - j & j\end{matrix} ] .$$

Since the coherent transmission is indicated for the PUSCH, the second user device 102(2) may select all of the layers of the data, i.e., x⁽¹⁾, x⁽²⁾, x⁽³⁾, and x⁽⁴⁾. The second user device 102(2) may select antenna port 5 and antenna port 11 for PUSCH transmission. After precoding, the output is

$$\frac{1}{4} [ \begin{matrix}{x}^{( 1 )} - {x}^{( 2 )} + {x}^{( 3 )} - {x}^{( 4 )} \\ j * {x}^{( 1 )} - j * {x}^{( 2 )} - j * {x}^{( 3 )} + j * {x}^{( 4 )}\end{matrix} ] ,$$

which is transmitted by the second user device 102(2).

In addition or alternatively, in some implementations where a user device 102 determines a subset of antenna ports and/or a subset of layers based on a subset of a precoding matrix, a number of the layers configured by the network device 104 may be equal to the number of columns of the precoding matrix configured by the network device 104. In some of these implementations, a first layer may correspond to a first column of the precoding matrix, a second layer may correspond to a second column of the precoding matrix, and so on. In addition or alternatively, a number of antenna ports configured by the network device 104 may be equal to the number of the columns of the precoding matrix configured by the network device 104. The first antenna port may correspond to the first column of the precoding matrix, the second antenna port may correspond to the second column of the precoding matrix, and so on.

In addition or alternatively, in some implementations, a user device 102 (e.g., the first user device 102(1) or the second user device 102(2)) may determine a subset of the precoding matrix. For at least some of these implementations, one or more columns of the precoding matrix may be removed from the subset of the precoding matrix. The user device 102 may determine that the subset of the layers may include the layers that correspond to the columns included in the subset of the precoding matrix. In other words, if a column is removed from the subset of the precoding matrix, then the corresponding layer may also be removed from the subset of the configured layers. Similarly, the user device 102 may determine that the subset of the first antenna port configuration may include the antenna ports that correspond to the columns of the precoding matrix included in the subset of the precoding matrix. In other words, if a column is removed from the subset of the precoding matrix, then the corresponding antenna port may also be removed from the subset of the first antenna port configuration.

In some of these implementations, the network device 104 may configure the subset of the precoding matrix for the user device 102 to include the first K rows (or only the first K rows) of the precoding matrix, where K is an integer and 1<=K<=X. In turn, or in response, the user device 102 may determine that the subset of the antenna port includes (or only includes) the first K antenna ports of the first antenna port configuration. In a first case, in event that the subset of the precoding matrix includes a column comprising all ‘zeros’, then the user device 102 may determine that the subset of the layers may include all of the configured layers. In event that the column comprising all ‘zeros’ is removed from the subset of the precoding matrix, the user device 102 may determine that the subset of the layers may include (or only include) the first K layers of the configured layers. In a second case, in event that a coherent transmission is configured (or indicated) for the user device 102, the user device 102 may determine that the subset of the layers includes all of the configured layers. In event that a non-coherent transmission or partial coherent transmission is configured (or indicated) for the user device 102, the user device 102 may determine that the subset of the layers includes the first K layers (or only the first K layers) of the configured layers. In event that the non-coherent transmission or partial coherent transmission is configured (or indicated) for the user device 102, the user device 102 may remove the column that includes all ‘zeros’ from the subset of the precoding matrix.

In some of these implementations, the network device 104 may configure the subset of the precoding matrix for the user device 102 to include the last K rows (or only the last K rows) of the precoding matrix, where K is an integer and 1<=K<=X. In turn, or in response, the user device 102 may determine that the subset of the antenna port includes (or only includes) the last K antenna ports of the first antenna port configuration. In a first case, in event that the subset of the precoding matrix includes a column comprising all ‘zeros’, then the user device 102 may determine that the subset of the layers may include all of the configured layers. In event that the column comprising all ‘zeros’ is removed from the subset of the precoding matrix, the user device 102 may determine that the subset of the layers may include (or only include) the last K layers of the configured layers. In a second case, in event that a coherent transmission is configured (or indicated) for the user device 102, the user device 102 may determine that the subset of the layers includes all of the configured layers. In event that a non-coherent transmission or partial coherent transmission is configured (or indicated) for the user device 102, the user device 102 may determine that the subset of the layers includes the last K layers (or only the last K layers) of the configured layers. In event that the non-coherent transmission or partial coherent transmission is configured (or indicated) for the user device 102, the user device 102 may remove the column that includes all ‘zeros’ from the subset of the precoding matrix.

In some embodiments, a subset of a precoding matrix and/or a subset of layers may be determined based on a subset of antenna ports. For example, the network device 104 may configure only the subset of the first antenna port configuration for the user device 102. In turn, or in response, the user device 102 may determine the precoding matrix subset from the configured precoding matrix according to the configuration of the subset of the antenna port configuration. In addition or alternatively, the user device 102 may determine the subset of layers from the configured layers according to the configuration of the subset of the antenna port configuration.

In some of these implementations, the network device 104 may configure the subset of the first antenna port configuration to include (or only include) the odd antenna ports. In turn, the user device 102 may determine that the subset of the precoding matrix includes (or only includes) the odd rows of the precoding matrix. In addition or alternatively, the user device 102 may determine that the subset of the layers may include (or only include) the odd data layers. In some other of these implementations, the network device 104 may configure the subset of the first antenna port configuration to include (or only include) the even antenna ports. In turn, the user device 102 may determine that the subset of the precoding matrix may include (or only include) the even rows of the precoding matrix. In addition or alternatively, the user device 102 may determine that the subset of the layers may include (or only include) the even data layers.

Additionally, for at least some implementations, for data transmission with two layers, two antenna ports may be needed. For such implementations, the network device 104 may configure the subset of antenna ports to include the first antenna port for the first user device 102(1). In turn, or in response, the first user device 102(1) may determine that the subset of the precoding matrix includes (or only includes) the odd rows of the configured precoding matrix. In addition or alternatively, the first user device 102(1) may determine the subset of the layers to only include the first data layer. The network device 104 may configure the subset of antenna ports to include the second antenna port for the second user device 102(2). In turn, or in response, the second user device 102(2) may determine that the subset of the precoding matrix includes (or only includes) the even rows of the configured precoding matrix. In addition or alternatively, the second user device 102(2) may determine the subset of the layers to only include the second data layer.

In some of these implementations, the network device 104 may configure the subset of the first antenna port configuration to include (or only include) the first K antenna ports, where K is an integer and 1<=K<=N. In turn, the user device 102 may determine that the subset of the precoding matrix includes (or only includes) the first K rows and/or the first K columns of the precoding matrix. In addition or alternatively, the user device 102 may determine that the subset of the layers may include (or only include) the first K data layers. In some other of these implementations, the network device 104 may configure the subset of the first antenna port configuration to include (or only include) the last K antenna ports, where K is an integer and 1<=K<=N. In turn, the user device 102 may determine that the subset of the precoding matrix may include (or only include) the last K rows and/or the last K columns of the precoding matrix. In addition or alternatively, the user device 102 may determine that the subset of the layers may include (or only include) the last K data layers.

In addition or alternatively, in some implementations where a subset of antenna ports and/or a subset of a precoding matrix is determined based on a subset of layers, the network device 104 may configure only the subset of the layers for the user device 102. In turn, or in response, the user device 102 may determine the precoding matrix subset from the configured precoding matrix according to the configuration of the subset of layers. In addition or alternatively, the user device 102 may determine the antenna port subset from the first antenna port configuration according to the configuration of the subset of layers.

For some of these implementations, the network device 104 may configure the subset of the layers to include (or only include) the odd layers of the Z layers. In turn, or in response, the user device 102 may determine that the subset of the precoding matrix includes (or only includes) the odd rows and/or odd columns of the precoding matrix. In addition or alternatively, the user device 102 may determine that subset of the antenna ports includes (or only includes) the odd antenna ports of the N antenna ports. In some other of these implementations, the network device 104 may configure the subset of the layers to include (or only include) the even layers of the Z layers. In turn, or in response, the user device 102 may determine the subset of the precoding matrix to include (or only include) the even rows and/or the even columns of the precoding matrix. In addition or alternatively, the user device 102 may determine the subset of the antenna ports to include (or only include) the even antenna ports of the N antenna ports.

For some of these implementations, the network device 104 may configure the subset of the layers to include (or only include) the first K layers of the Z layers, where K is an integer and 0<=K<=Z. In turn, or in response, the user device 102 may determine that the subset of the precoding matrix includes (or only includes) the first K rows and/or first K columns of the precoding matrix. In addition or alternatively, the user device 102 may determine that the subset of the antenna ports includes (or only includes) the first K antenna ports of the N antenna ports. In some other of these implementations, the network 104 may configure the subset of the layers to include (or only include) the last K layers of the Z layers, where K is an integer and 0<=K<=Z. In turn, or in response, the user device 102 may determine the subset of the precoding matrix to include (or only include) the last K rows and/or the last K columns of the precoding matrix. In addition or alternatively, the user device 102 may determine the subset of the antenna ports to include (or only include) the last K antenna ports of the N antenna ports.

In any case, the UE may remove a column that comprises all ‘zero’ from the subset of the precoding matrix when the UE determines the subset of the precoding matrix.

Table 4 below illustrates an example where the network device 104 configures a precoding matrix for a user device 102 (i.e., the first user device 102(1) or the second user device 102(2). Suppose in this example that the network 104 may configure two antenna ports for the user device 102. Further, suppose that the network device 104 configures the first antenna port to be for the first user device 102(1), and configures the second antenna port for the second user device 102(2). According to the antenna port configuration, the first user device 102(1) may select the first row and the third row of the precoding matrix. Additionally, the second user device 102(2) may select the second row and the fourth row of the precoding matrix. Also, the network device 104 may indicate a precoding matrix

$$\frac{1}{2} [ \begin{matrix}1 & 0 \\ 0 & 1 \\ j & 0 \\ 0 & - 1\end{matrix} ] .$$

Correspondingly, the subset of the precoding matrix that the first user device 102(1) selects may be

$$\frac{1}{2} [ \begin{matrix}1 & 0 \\ j & 0\end{matrix} ] .$$

Additionally, the subset of the precoding matrix that the second user device 102(2) selects may be

$$\frac{1}{2} [ \begin{matrix}0 & 1 \\ 0 & - 1\end{matrix} ] .$$

TABLE 4
Precoding matrix

| | | | |
|---|---|---|---|
| $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |

| | | | |
|---|---|---|---|
| $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

In addition or alternatively, in some implementations, the network device 104 may configure the coherent transmission for at least one user device 102, such as the first user device 102(1) and/or the second user device 102(2). In addition or alternatively, the network device 104 may configure a first coherent group for the first user device 102(1) and/or configure a second coherent group for the second user device 102(2).

In some implementations involving N antenna ports, the first coherent group may include (or only include) the odd antenna ports (e.g., the first antenna port, the third antenna port, the fifth antenna port, and so on) of the N antenna ports. In addition or alternatively, the second coherent group may include (or only include) the even antenna ports (e.g., the second antenna port, the fourth antenna port, the sixth antenna port, and so on) of the N antenna ports.

To illustrate, suppose that the network device 104 indicates antenna port 0, antenna port 2, antenna port 4, and antenna port 6 for the first user device 102(1) and the second user device 102(2). In turn, or in response, the first user device 102(1) may use the antenna port 0 and antenna port 4 for transmitting the PUSCH or PUSCH DMRS, and/or the second user device 102(2) may use the antenna port 2 and antenna port 6 for transmitting the PUSCH or PUSCH DMRS.

In some implementations involving N antenna ports, the first coherent group may include (or only include) the first one or more antenna ports of the N antenna ports. In addition or alternatively, the second coherent group may include (or only include) the last one or more antenna ports of the N antenna ports.

In some implementations involving a precoding matrix with N antenna ports, the first coherent group may include (or only include) the odd rows (e.g., the first row, the third row, the fifth row, and so on) of the precoding matrix. In addition or alternatively, the second coherent group may include (or only include) the even rows (e.g., the second row, the fourth row, the sixth row, and so on) of the precoding matrix.

In addition or alternatively, in some implementations involving a precoding matrix with two antenna ports, the first coherent group may include the first row of the precoding matrix. Correspondingly, the first user device 102(1) may use the first row of the precoding matrix for the data channel processing. In addition or alternatively, for the precoding matrix with two antenna ports, the second coherent group may include the second row of the precoding matrix. Correspondingly, the second user device 102(2) may use the second row of the precoding matrix for the data channel processing.

To illustrate, as an example, suppose a precoding matrix with two antenna ports, such as in Table 5 below. Further, suppose that the network device 104 indicates the precoding matrix

$$\frac{1}{\sqrt{2}} [ \begin{matrix}1 \\ - 1\end{matrix} ]$$

for the first user device 102(1) and the second user device 102(2). In turn, or in response, the first user device 102(1) may use the subset

$$\frac{1}{\sqrt{2}} [ 1 ]$$

for the data channel processing, and/or the second user device 102(2) may use the subset

$$\frac{1}{\sqrt{2}} [ - 1 ]$$

for the data channel processing.

TABLE 5
Precoding matrix

| | | | | | |
|---|---|---|---|---|---|
| $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ |

Additionally, in some implementations involving a precoding matrix with four antenna ports, the first coherent group may include the first row and the third row of the precoding matrix. Correspondingly, the first user device 102(1) may use the first row and the third row of the precoding matrix for the data channel processing. In addition or alternatively, for the precoding matrix with four antenna ports, the second coherent group may include the second row and the fourth row of the precoding matrix. Correspondingly, the second user device 102(2) may use the second row and the fourth row of the precoding matrix for the data channel processing.

To illustrate, Table 6 below provides an example involving a precoding matrix with four antenna ports. In the example, suppose that the network device 104 indicates the precoding matrix

$$\frac{1}{2} [ \begin{matrix}1 \\ j \\ - j \\ 1\end{matrix} ]$$

for the first user device 102(1) and the second user device 102(2). The first user device 102(1) may use the subset

$$\frac{1}{2} [ \begin{matrix}1 \\ - j\end{matrix} ]$$

for the data channel processing, and/or the second user device 102(2) may use the subset

$$\frac{1}{2} [ \begin{matrix}j \\ 1\end{matrix} ]$$

for the data channel processing.

TABLE 6
Precoding matrix

| | | | | | | | |
|---|---|---|---|---|---|---|---|
| $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

In some implementations involving a precoding matrix with N antenna ports, the first coherent group may include (or only include) the first one or more rows of the precoding matrix, and/or the first one or more rows of the precoding matrix. In addition or alternatively, the second coherent group may include (or only include) the last one or more rows of the precoding matrix, and/or the last one or more columns of the precoding matrix.

In addition or alternatively, in some implementations involving data channel transmission with Z layers, the first coherent group may include (or only include) the odd layers (e.g., the first layer, the third layer, the fifth layer, and so on) of the Z layers. Additionally, the second coherent group may include the even layers (e.g., the second layer, the fourth layer, the sixth layer, and so on) of the Z layers. After layer mapping, the first user device 102(1) may select the odd layers of the data. Additionally, the first user device 102(1) may only further process and transmit the odd layers of the data. In addition or alternatively, the second user device 102(2) may select the even layers of the data. Additionally, the second user device 102(2) may only further process and transmit the even layers of the data.

For the channel transmission with two layers, the processing the layer mapping is shown as follows:

$${x}^{( 0 )} ( i ) = {d}^{( 0 )} ( 2 i )$$

$${x}^{( 1 )} ( i ) = {d}^{( 0 )} ( 2 i + 1 )$$

where x⁽⁰⁾(i) is the data of the first layer, x⁽¹⁾(i) is the data of the second layer, d⁽⁰⁾(i) is the data to be performed layer mapping. In some implementations, the first user device 102(1) may select only the data of x⁽⁰⁾(i), and in turn, the first user device 102(1) may process only the data of x⁽⁰⁾(i). In addition or alternatively, the second user device 102(2) may select only the data of x⁽¹⁾(i), and in turn, the second user device 102(2) may process only the data of x⁽¹⁾(i). As a result, the first user device 102(1) may communicate (transmit or receive) only the data of x⁽⁰⁾(i), and/or the second user device 102(2) may communicate (transmit or receive) only the data of x⁽¹⁾(i).

For the channel transmission with three layers, the processing the layer mapping is shown as follows:

$$\begin{matrix}{x}^{( 0 )} ( i ) = {d}^{( 0 )} ( 3 i ) \\ {x}^{( 1 )} ( i ) = {d}^{( 0 )} ( 3 i + 1 ) \\ {x}^{( 2 )} ( i ) = {d}^{( 0 )} ( 3 i + 2 )\end{matrix} {M}_{s y m b}^{layer} = {M}_{s y m b}^{( 0 )} / 3$$

where x⁽⁰⁾(i) is the data of the first layer, x⁽¹⁾(i) is the data of the second layer, x⁽²⁾(i) is the data of the third layer, d⁽⁰⁾(i) is the data to be performed layer mapping. In some of these implementations of channel transmission with three layers, the first user device 102(1) may select only the data of x⁽⁰⁾(i) and x⁽²⁾(i), and in turn, the first user device 102(1) may process only the data of x⁽⁰⁾(i) and x⁽²⁾(i). In addition or alternatively, the second user device 102(2) may select only the data of x⁽¹⁾(i), and in turn, the second user device 102(2) may process only the data of x⁽¹⁾(i). As a result, the first user device 102(1) may communicate (transmit or receive) only the data of x⁽⁰⁾(i) and x⁽²⁾(i), and/or the second user device 102(2) may communicate (transmit or receive) only the data of x⁽¹⁾(i).

In some implementations involving data channel transmission with Z layers, the first coherent group may include (or only include) the first one or more layers of the Z layers. Additionally, the second coherent group may include the last one or more layers of the Z layers. After layer mapping, the first user device 102(1) may select the first one or more layers of the data. Additionally, the first user device 102(1) may only further process and transmit the first one or more layers of the data. In addition or alternatively, the second user device 102(2) may select the last one or more layers of the data. Additionally, the second user device 102(2) may only further process and transmit the last one or more layers of the data.

In some implementations, the user device 102 may remove a column that comprises all ‘zeros’ from the subset of the precoding matrix when the user device 102 determines the subset of the precoding matrix. In addition or alternatively, in some implementations, when the user device 102 determines the subset of precoding matrix, the user device 102 may change the coefficient of the precoding matrix for normalization processing. For example, the precoding matrix is

$$\frac{1}{2} [ \begin{matrix}1 \\ j \\ 1 \\ j\end{matrix} ] .$$

If the subset of the precoding matrix is

$$[ \begin{matrix}1 \\ 1\end{matrix} ]$$

by selecting the first row and the third row, then the coefficient may be changed from ½ to

$$\frac{1}{\sqrt{2}}$$

for normalization processing. The user device 102 may determine that the subset of the precoding matrix is

$$\frac{1}{\sqrt{2}} [ \begin{matrix}1 \\ 1\end{matrix} ]$$

In addition or alternatively, in some implementations, the network device 104 may configure a plurality of sounding reference signal (SRS) resources (e.g., one or more SRS resources) for a user device 102 (e.g., the first user device 102(1) or the second user device 102(2)). The configuration of an SRS resource may include at least one of an orthogonal frequency division multiplexing (OFDM) symbol pattern in a slot, the slot pattern, the resource element pattern in a resource block (RB), the start RB, the number of RBs, the number of the antenna ports, a hopping method, or spatial information. In addition or alternatively, an SRS resource may include one or more antenna ports. Each antenna port may occupy a different time domain resource, and/or a frequency domain resource, and/or a code domain resource. Alternatively, an antenna port may correspond to a time domain resource, and/or a frequency resource, and/or a code domain resource.

In addition or alternatively, the network device 104 may further configure the user device 102 to occupy at least a part of a set of antenna ports. The user device 102 may transmit the SRS with the part of the set of antenna ports on the resource corresponding to the part of the set of antenna ports.

To illustrate as an example, the network device 104 may configure that an SRS resource has a set of antenna ports that includes four antenna ports, denoted as antenna port 0, antenna port 1, antenna port 2, and antenna port 3. Suppose for example, that a resource block (RB) includes twelve resource elements (REs) in the frequency domain, including RE 0-RE 11. Further, suppose that the SRS resource occupies four REs per RB, where antenna port 0 corresponds to RE 0, antenna port 1 corresponds to RE 3, antenna port 2 corresponds to RE 6, and antenna port 3 corresponds to RE 9. For such a configuration, the network device 104 may configure antenna port 0 and antenna port 1 for the first user device 102(1). In turn, or in response, the first user device 102(1) may transmit the SRS with only two antenna ports (e.g., antenna port 0 and antenna port 1) of the set of four antenna ports on the RE 0 and RE 3 of the SRS resource. In addition or alternatively, the network device 104 may configure antenna port 2 and antenna port 3 for the second user device 102(2). In turn, or in response, the second user device 102(2) may transmit the SRS with only two antenna ports (e.g., antenna port 2 and antenna port 3) of the set of four antenna ports on the RE 6 and RE 9 of the SRS resource.

The description and accompanying drawings above provide specific example embodiments and implementations. The described subject matter may, however, be embodied in a variety of different forms and, therefore, the covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects.

A first aspect includes a method for wireless communication that includes: configuring, by a network device, a first configuration for a data channel for a user device; indicating, by the network device, at least a subset of the first configuration to the user device; and communicating, by the network device between the user device, the data channel processed with the subset of the first configuration.

A second aspect includes the first aspect, and further includes wherein the first configuration comprises at least one of: a first antenna port configuration for the data channel, one or more layers of the data channel, or a precoding matrix for the data channel.

A third aspect includes any of the first aspect or the second aspect, and further includes wherein the subset of the first configuration comprises at least one of: a subset of a first antenna port configuration for the data channel, a subset of a total number of layers of the data channel, or a subset of a precoding matrix for the data channel.

A fourth aspect includes any of the first through third aspects, and further includes: configuring, by the network device, at least one of a coherent transmission or a first coherent group for the user device.

A fifth aspect includes the fourth aspect, and further includes wherein the first coherent group corresponds to at least one of: a set of odd layers of the data channel, a set of odd antenna ports of the data channel, or a set of odd rows of a precoding matrix.

A sixth aspect includes any of the fourth or fifth aspects, and further includes: configuring, by the network device, a second coherent group for a second user device.

A seventh aspect includes the sixth aspect, and further includes wherein the second coherent group corresponds to at least one of: a set of even layers of the data channel, a set of even antenna ports of the data channel, or a set of even rows of a precoding matrix.

An eighth aspect includes any of the third through seventh aspects, and further includes: indicating, by the network device, at least the subset of the first antenna port configuration for the data channel for the user device, wherein the user device determines the subset of the total number of layers of the data channel or the subset of the precoding matrix for the data channel based on the subset of the first antenna port configuration.

A ninth aspect includes any of the third through seventh aspects, and further includes indicating, by the network device, at least the subset of the total number of layers for the data channel for the user device, wherein the user device determines the subset of the first antenna port configuration for the data channel or the subset of the precoding matrix for the data channel based on the subset of a total number of layers.

A tenth aspect includes any of the third through seventh aspects, and further includes: indicating, by the network device, at least the subset of the precoding matrix for the data channel for the user device, wherein the user device determines the subset of the first antenna port configuration for the data channel or the subset of the total number of layers for the data channel based on the subset of the precoding matrix.

An eleventh aspect includes the first aspect, and further includes wherein a subset of a total number of layers of data is processed using a subset of a precoding matrix and transmitted using a subset of antenna ports.

A twelfth aspect includes a method for wireless communication that includes: receiving, by a user device from a network device, at least a subset of a first configuration for a data channel; and communicating, by the user device between the network device, the data channel processed with the subset of the first configuration.

A thirteenth aspect includes the twelfth aspects, and further includes wherein the first configuration comprises at least one of: a first antenna port configuration for the data channel, one or more layers of the data channel, or a precoding matrix for the data channel.

A fourteenth aspect includes any of the twelfth or thirteenth aspects, and further includes wherein the subset of the first configuration comprises at least one of: a subset of a first antenna port configuration for the data channel, a subset of a total number of layers of the data channel, or a subset of a precoding matrix for the data channel.

A fifteenth aspect includes any of the twelfth through fourteenth aspects, and further includes wherein the subset of the first configuration comprises a subset of a first antenna port configuration for the data channel, and: determining, by the user device, a subset of a total number of layers of the data channel or a subset of a precoding matrix for the data channel based on the subset of the first antenna port configuration received from the network device.

A sixteenth aspect includes any of the twelfth through fourteenth aspects, and further includes wherein the subset of the first configuration comprises a subset of a total number of layers for the data channel, and: determining, by the user device, a subset of the first antenna port configuration for the data channel or a subset of a precoding matrix for the data channel based on the subset of the total number of layers received from the network device.

A seventeenth aspect includes any of the twelfth through fourteenth aspects, and further includes wherein the subset of the first configuration comprises a subset of a precoding matrix for the data channel, and: determining, by the user device, a subset of a first antenna port configuration for the data channel or a subset of a total number of layers for the data channel based on the subset of the precoding matrix received from the network device.

An eighteenth aspect includes the twelfth aspect, and further includes: receiving, by the user device, at least one of a coherent transmission or a first coherent group configured by the network device, and selecting, by the user device, at least one of: a subset of a total number of layers for the data channel, a subset of a first antenna port configuration of the data channel, or a subset of a precoding matrix for the data channel according to the first coherent group.

A nineteenth aspect includes the eighteenth aspect, and further includes wherein the first coherent group corresponds to at least one of: a set of odd layers of the data channel, a set of odd antenna ports of the data channel, or a set of odd rows of a precoding matrix.

A twentieth aspect includes the nineteenth aspect, and further includes: processing, by the user device, at least one of: only the set of odd layers of the data channel or only the set of odd rows of the precoding matrix when the user device is configured with the first coherent group.

A twenty-first aspect includes the twelfth aspect, and further includes: receiving, by the user device, at least one of a coherent transmission or a second coherent group configured by the network device, and selecting, by the user device, at least one of: a subset of a total number of layers for the data channel, a subset of a first antenna port configuration of the data channel, or a subset of a precoding matrix for the data channel according to the second coherent group.

A twenty-second aspect includes the twenty-first aspect, and further includes wherein the second coherent group corresponds to at least one of: a set of even layers of the data channel, a set of even antenna ports of the data channel, or a set of even rows of a precoding matrix.

A twenty-third aspect includes the twenty-second aspect, and further comprising: processing, by the user device, at least one of: only the set of even layers of the data channel or only the set of even rows of the precoding matrix when the user device is configured with the second coherent group.

A twenty-fourth aspect includes the twelfth aspect, and further includes wherein a subset of a total number of layers of data is processed using a subset of a precoding matrix and transmitted using a subset of antenna ports.

A twenty-fifth aspect includes a wireless communications apparatus that includes a processor and a memory, wherein the processor is configured to read code from the memory to implement any of the first through twenty-fourth aspects.

A twenty-sixth aspect includes a computer program product comprising a computer-readable program medium comprising code stored thereupon, the code, when executed by a processor, causing the processor to implement any of the first through twenty-fourth aspects.

In addition to the features mentioned in each of the independent aspects enumerated above, some examples may show, alone or in combination, the optional features mentioned in the dependent aspects and/or as disclosed in the description above and shown in the figures.

What is claimed is:

1. A method for wireless communication, the method comprising:
configuring, by a network device, a first configuration for a data channel for a user device;
indicating, by the network device, at least a subset of the first configuration to the user device; and
communicating, by the network device between the user device, the data channel processed with the subset of the first configuration.

2. The method of claim 1, wherein the first configuration comprises at least one of: a first antenna port configuration for the data channel, one or more layers of the data channel, or a precoding matrix for the data channel; or
the subset of the first configuration comprises at least one of: a subset of a first antenna port configuration for the data channel, a subset of a total number of layers of the data channel, or a subset of a precoding matrix for the data channel.

3. (canceled)

4. The method of claim 1, further comprising:
configuring, by the network device, at least one of a coherent transmission or a first coherent group for the user device.

5. The method of claim 4, wherein the first coherent group corresponds to at least one of: a set of odd layers of the data channel, a set of odd antenna ports of the data channel, or a set of odd rows of a precoding matrix.

6. The method of claim 4, further comprising:
configuring, by the network device, a second coherent group for a second user device.

7. The method of claim 6, wherein the second coherent group corresponds to at least one of: a set of even layers of the data channel, a set of even antenna ports of the data channel, or a set of even rows of a precoding matrix.

8. The method of claim 2, further comprising,
indicating, by the network device, at least the subset of the first antenna port configuration for the data channel for the user device, wherein the user device determines the subset of the total number of layers of the data channel or the subset of the precoding matrix for the data channel based on the subset of the first antenna port configuration; or
indicating, by the network device, at least the subset of the total number of layers for the data channel for the user device, wherein the user device determines the subset of the first antenna port configuration for the data channel or the subset of the precoding matrix for the data channel based on the subset of a total number of layers; or
indicating, by the network device, at least the subset of the precoding matrix for the data channel for the user device, wherein the user device determines the subset of the first antenna port configuration for the data channel or the subset of the total number of layers for the data channel based on the subset of the precoding matrix.

9-10. (canceled)

11. The method of claim 1, wherein a subset of a total number of layers of data is processed using a subset of a precoding matrix and transmitted using a subset of antenna ports.

12. A method for wireless communication, the method comprising:
receiving, by a user device from a network device, at least a subset of a first configuration for a data channel; and
communicating, by the user device between the network device, the data channel processed with the subset of the first configuration.

13. The method of claim 12, wherein the first configuration comprises at least one of: a first antenna port configuration for the data channel, one or more layers of the data channel, or a precoding matrix for the data channel; or
the subset of the first configuration comprises at least one of: a subset of a first antenna port configuration for the data channel, a subset of a total number of layers of the data channel, or a subset of a precoding matrix for the data channel.

14. (canceled)

15. The method of claim 12, wherein
the subset of the first configuration comprises a subset of a first antenna port configuration for the data channel, the method further comprising: determining, by the user device, a subset of a total number of layers of the data channel or a subset of a precoding matrix for the data channel based on the subset of the first antenna port configuration received from the network device; or
the subset of the first configuration comprises a subset of a total number of layers for the data channel, the method further comprising: determining, by the user device, a subset of the first antenna port configuration for the data channel or a subset of a precoding matrix for the data channel based on the subset of the total number of layers received from the network device; or
the subset of the first configuration comprises a subset of a precoding matrix for the data channel, the method further comprising: determining, by the user device, a subset of a first antenna port configuration for the data channel or a subset of a total number of layers for the data channel based on the subset of the precoding matrix received from the network device.

16-17. (canceled)

18. The method of claim 12, further comprising:
receiving, by the user device, at least one of a coherent transmission or a first coherent group configured by the network device, and
selecting, by the user device, at least one of: a subset of a total number of layers for the data channel, a subset of a first antenna port configuration of the data channel, or a subset of a precoding matrix for the data channel according to the first coherent group.

19. The method of claim 18, wherein the first coherent group corresponds to at least one of: a set of odd layers of the data channel, a set of odd antenna port of the data channel, or a set of odd rows of a precoding matrix.

20. The method of claim 19, further comprising:
processing, by the user device, at least one of: only the set of odd layers of the data channel or only the set of odd rows of the precoding matrix when the user device is configured with the first coherent group.

21. The method of claim 12, further comprising:
receiving, by the user device, at least one of a coherent transmission or a second coherent group configured by the network device, and
selecting, by the user device, at least one of: a subset of a total number of layers for the data channel, a subset of a first antenna port configuration of the data channel, or a subset of a precoding matrix for the data channel according to the second coherent group.

22. The method of claim 21, wherein the second coherent group corresponds to at least one of: a set of even layers of the data channel, a set of even antenna ports of the data channel, or a set of even rows of a precoding matrix.

23. The method of claim 22, further comprising:
processing, by the user device, at least one of: only the set of even layers of the data channel or only the set of even rows of the precoding matrix when the user device is configured with the second coherent group.

24. The method of claim 12, wherein a subset of a total number of layers of data is processed using a subset of a precoding matrix and transmitted using a subset of antenna ports.

25. A user device comprising a processor and a memory, wherein the processor is configured to read code from the memory to implement a method comprising:
receiving, by the user device from a network device, at least a subset of a first configuration for a data channel; and
communicating, by the user device between the network device, the data channel processed with the subset of the first configuration.

26. A network device comprising a processor and a memory, wherein the processor is configured to read code from the memory to implement the method of claim 1.
